(19) United States
(12) Patent Application Publication
(10) Pub. No.: US 2006/0149910 A1
(43) Pub. Date: Jul. 6, 2006

(54) Apparatus and method for reproducing multimedia data using the virtual file system

(75) Inventors: Kwang-min Kim, Anyang-si (KR); Duhee Lee, New York, NY (US)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/289,496

(22) Filed: Nov. 30, 2005

(30) Foreign Application Priority Data
Nov. 30, 2004 (KR) 2004-99047

(51) Int. Cl. G06F 12/00; G06F 12/14

(52) U.S. Cl. 711/162

(57) ABSTRACT

An apparatus and a method that creates a virtual file system by combining directory information of data recorded on an information storage medium and directory information of data downloaded from a network and reproducing multimedia data with reference to the virtual file system. The reproducing apparatus includes: a local storage to store data downloaded from a network; a reading unit to read data stored in an information storage medium and the data stored in the local storage; and a reproducing unit to create a virtual file system and to reproduce the data stored in the local storage together with the data stored in the information storage medium with reference to the virtual file system. Therefore, an application which accesses data stored in a local storage or an information storage medium may be created, and new contents may be easily added.

### CROSS-REFERENCE TO RELATED APPLICATION

This application claims the benefit of Korean Application No. 2004-99047, filed Nov. 30, 2004, in the Korean Intellectual Property Office, the disclosure of which is incorporated herein by reference.

### BACKGROUND OF THE INVENTION

1. Field of the Invention

An aspect of the present invention relates to reproducing multimedia data recorded on an information storage medium, and, more particularly, to an apparatus and method that creates a virtual file system by combining directory information of data recorded on an information storage medium and directory information of data downloaded from a network and reproducing multimedia data with reference to the virtual file system.

2. Description of the Related Art

Moving-picture data recorded on information storage media such as DVDs include audio-visual (AV) data that is compression-encoded and navigation data that is needed to control the reproduction of the AV data. More specifically, AV data includes an AV stream having video, audio and/or subtitles, which are encoded according to a motion picture experts group (MPEG) standard. AV data may further include additional information, such as encoding properties of an AV stream or an entry point for random access, and a play list to arrange the order in which moving pictures are reproduced.

Navigation data includes navigation commands to control the reproduction of AV data. Examples of the navigation commands include a command to reproduce a play list and a command to jump to another play list. AV data may be reproduced with reference to navigation data stored in an information storage medium, allowing a user to watch high-quality moving pictures such as movies.

However, when moving-picture data is structured as described above, AV data included in the moving-picture data may not be easily edited and modified. Furthermore, moving-picture data cannot offer diverse interactive operations. Therefore, applications having programming operations are also required in addition to moving-picture data.

In particular, an operation to access an external database through a network, to download new contents from the external database, and to reproduce the downloaded contents together with moving-picture data stored in an information storage medium is required. However, since directory information of the moving-picture data stored in the information storage medium exists separately from directory information of the downloaded contents, the directory information of the moving-picture data and that of the downloaded contents must be combined into new directory information to subsequently reproduce the downloaded contents and the moving-picture data.

### SUMMARY OF THE INVENTION

An aspect of the present invention provides an apparatus and method that creates a virtual file system by combining directory information of data recorded on an information storage medium and directory information of contents downloaded from a network and subsequently reproducing the downloaded contents and the data with reference to the virtual file system.

According to an aspect of the present invention, there is provided a reproducing apparatus including: a local storage to store data downloaded from a network; a reading unit to read data stored in an information storage medium and to read the data stored in the local storage; and a reproducing unit to create a virtual file system and to subsequently reproduce the data stored in the information storage medium in connection with the data stored in the local storage with reference to the virtual file system.

The virtual file system may have a format that is similar to a format of directory information stored in the information storage medium.

The reproducing unit may include a module manager to create the virtual file system by combining directory information of the data stored in the local storage and directory information of the data stored in the information storage medium.

The virtual file system may include an application directory that relates to data created when an application, which is stored in the information storage medium or the local storage and which is executed, is stored.

According to another aspect of the present invention, there is provided a method of reproducing multimedia data using a virtual file system, the method including: storing data downloaded from a network in a local storage; reading data stored in an information storage medium and the data stored in the local storage; and creating the virtual file system and reproducing the data stored in the information storage medium in connection with the data stored in the local storage with reference to the virtual file system.

According to another aspect of the present invention, there is provided a method of reproducing multimedia data using a virtual file system, the method including: creating a virtual file system; requesting data from the virtual file system using a reproduction unit or an application which reproduces audio-visual data; reading data from an information storage medium or downloading data from a server through a network with reference to the virtual file system; updating the virtual file system; and reproducing the data read from the information storage medium in connection with the downloaded data with reference to the updated virtual file system.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates types of data recorded on an information storage medium according to an embodiment of the present invention;

FIG. 2 illustrates the structure of multimedia data recorded on the information storage medium of FIG. 1;

FIG. 3 is a block diagram illustrating the structure of the clip audio-visual (AV) stream of FIG. 2;

FIG. 4 illustrates a directory structure of the information storage medium of FIG. 1;

FIG. 5 is a view illustrating a method of creating a virtual file system according to an embodiment of the present invention;

FIG. 6 is a block diagram of a reproducing apparatus according to an embodiment of the present invention; and

FIG. 7 is a flowchart illustrating a reproduction method using a virtual file system according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

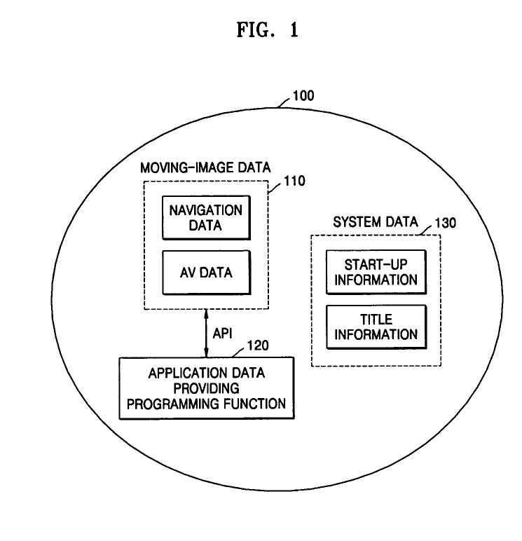

FIG. 1 illustrates types of data recorded on an information storage medium 100 according to an embodiment of the present invention. As illustrated in FIG. 1, moving-picture data 110, application data 120 to provide a programming operation, and system data 130 are recorded on the information storage medium 100.

The moving-picture data 110 is reproduction-mode data used to reproduce moving pictures and is also called core-mode or movie-mode data. The moving-picture data 110 includes audio-visual (AV) data that is compression-encoded and navigation data that is used to control the reproduction of the AV data. The AV data may be reproduced with reference to the navigation data stored in the information storage medium 100, allowing a user to watch high-quality moving pictures such as movies.

The application data 120 includes a programming operation to provide interactions with users and may be referred to as full-mode or program-mode data. The application data 120 may include various applications, such as a gaming operations using moving pictures, an operation of displaying a director's commentary while reproducing a portion of a moving picture, an operation of displaying additional information while reproducing a portion of a moving picture, or a chatting operation while reproducing a moving picture. For example, if a movie has been recorded on the information storage medium 100, information related to the movie such as the latest news about actors/actresses starring in the movie, events related to the movie, or updated subtitles which is stored on a web page or in a database may be retrieved and reproduced together with the movie.

To execute an application program while reproducing a moving picture, the application data 120 may include an application program interface (API) operation for a presentation engine that reproduces moving-picture information. Such application data 120 is written in a programming language, for example, C or Java. In the present disclosure, it will be understood that a Java application such as Xlet, which is a Java application that runs on digital TV receivers, will be described, although any Java application could be used.

The system data 130 includes start-up information and title information. The start-up information indicates the position of data to be first reproduced from the information storage medium 100 by a reproducing apparatus. The title information includes entry point information and attribute information of data for each title to be reproduced.

As is described above, the information storage medium 100 stores the programmable application data 120 in addition to the moving-picture data 110. Hence, the information storage medium 100 provides various interactive operations and allows for the reproduction of moving pictures. In particular, apart from the moving-picture data 110 that is recorded on the information storage medium 100, new contents may be downloaded from an external database to the information storage medium 100 and then reproduced. Moreover, the downloaded contents may be managed and used in subsequent reproductions.

An apparatus and method that creates a file system by combining directory information of the moving-picture data 110 recorded on the information storage medium 100 and directory information of new contents downloaded from an external database through a network and reproducing the moving-picture data 110 in connection with the downloaded contents with reference to the file system will be described below.

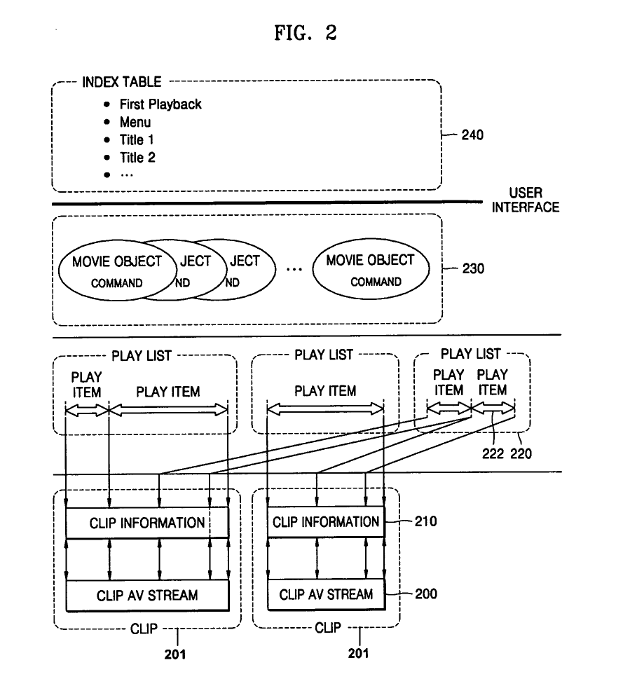

FIG. 2 illustrates a structure of multimedia data recorded on the information storage medium 100 of FIG. 1. As shown in FIG. 2, the structure of multimedia data has four layers, including a plurality of clips 201, a plurality of play lists 220, a plurality of movie objects 230, and an index table 240 in the four layers, respectively.

Each clip comprises an image recording unit and an object that includes an AV data stream for a high-quality movie and attribute information of the AV data stream. The AV data stream is referred to as a clip AV stream 200, and the attribute information is referred to as clip information 210. Each of the play lists 220 is a unit of a multimedia image reproduction. Each of the play lists 220 comprises reproduction sections of each clip, and each reproduction section is called a play item 222. The movie objects 230 respectively include navigation commands to reproduce a multimedia image. The navigation commands are used to start reproductions of the play lists 220, to switch between the movie objects 230, or to manage the reproduction of the play lists 220 according to a user's preference.

The index table 240 designates a movie object and a title to be first reproduced. The index table 240, which is in a top layer of the structure of multimedia data, defines a plurality of titles and a plurality of menus and includes start position information of the titles and the menus. Thus, a title or a menu selected by a title search or a user operation such as a menu call may be reproduced with reference to the index table 240. In addition, the index table 240 includes start position information of a title or a menu to be automatically first reproduced when the information storage medium 100 is inserted into a reproducing apparatus.

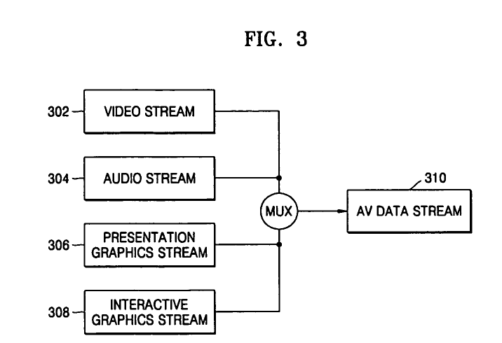

The structure of the clip AV stream 200, which is a compression-encoded multimedia image, will now be described. FIG. 3 is a block diagram illustrating the structure of the clip AV stream 200 of FIG. 2. With reference to FIG. 3, the information storage medium 100 is illustrated as storing an AV data stream 310 obtained by multiplexing a video stream 302, an audio stream 304, a presentation graphics stream 306 that provides subtitles, and an interactive graphics stream 308 that provides menus to interact with users. The AV data stream 310 may also be referred to as a main stream.

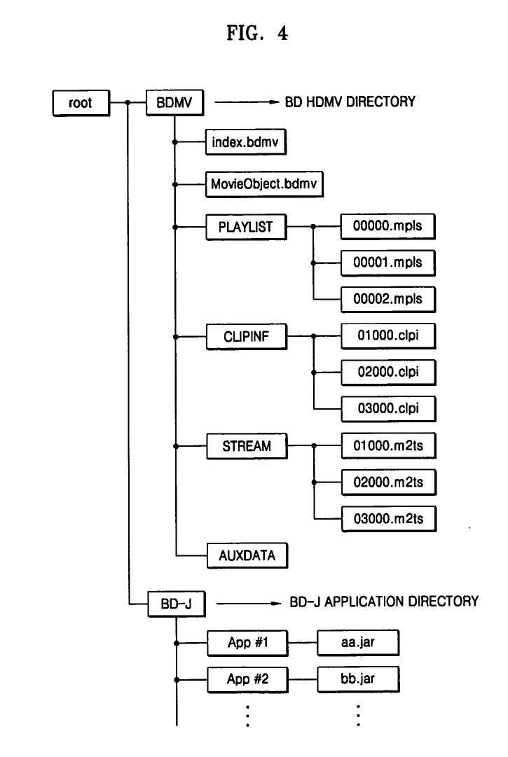

FIG. 4 illustrates a directory structure of the information storage medium 100 of FIG. 1. Referring to FIG. 4, directories of files related to multimedia data, which is recorded on the information storage medium 100, are illustrated. The high-quality moving-picture data 110 is stored in a BDMV directory under a root directory. Respective directories of the index table 240, the movie objects 230, the play lists 220, the clip information 210, the clipAV stream 200, and other data are provided under the BDMV directory. A BD-J directory, storing the application data 120 providing programming operations, is also located under the root directory. The BD-J directory provides an ID of each application and a directory of real data of each application.

Specifically, the index table 240 is stored in a file named index.bdmv, and the movie objects 230, including the navigation data, are recorded in a file named MovieObject.bdmv. In addition, the play lists 220, each of which is a unit of moving-picture reproduction, are recorded in files that have names having five characters with an mpls extension. These files are located in a PLAYLIST directory. The clip information 210 is stored in files that have names having five characters with a clpi extension. These files are located in a CLIPINF directory. The clip AV stream 200 is recorded in files that have names having five characters with an m2ts extension. These files are located in a STREAM directory. Thus, it will be understood that while the names of corresponding clip information files and clip AV stream files may be identical, the files themselves have different extensions. In addition, other data such as font files for text subtitles may be stored in an AUXDATA directory.

The application data 120 is recorded as a file named aa.jar in an App # 1 directory which indicates an ID of the application data 120, i.e., an application. There may be a plurality of applications, in which case real data of the applications is stored in the form of files named aa.jar, bb.jar, etc., in respective directories, i.e., IDs.

According to an embodiment of the present invention, the data described above may all be downloaded. However, for convenience, downloading of the play lists 220, the clip AV stream 200, and the application data 120 will be described below.

When a Java application included in the application data 120 is executed, a file may be downloaded from an external database through a network and then reproduced together with the moving-picture data 110 recorded on the information storage medium 100. In this case, one of a clip AV stream file, a play list file, and a different application file (in other words, a clip AV stream file, a play list file, or a different application file) may be downloaded to replace a target file recorded on the information storage medium 100. Alternatively, a clip AV stream file, a play list file, and a different application file may be downloaded as a single unit and added to files recorded on the information storage medium 100.

Downloaded data is stored in a local storage, which will be described later. A directory structure of the local storage may be identical to that of the information storage medium 100 illustrated in FIG. 4 such that the downloaded data may be stored accordingly and may be easily combined with the files recorded on the information storage medium 100.

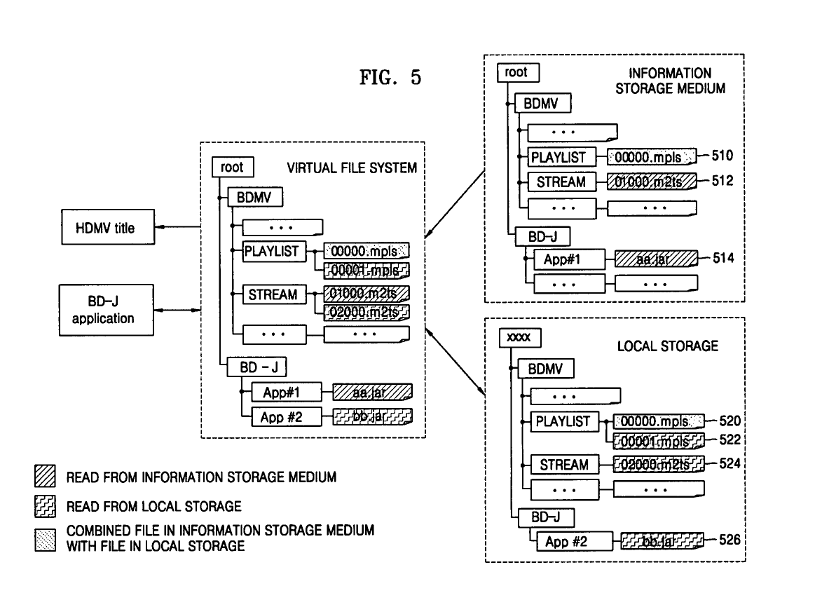

A method of creating a virtual file system using directory information of the information storage medium 100 illustrated in FIG. 4 and directory information of the local storage will now be described below with reference to FIG. 5, which is a view illustrating a method of creating a virtual file system according to an embodiment of the present invention.

To create the virtual file system, the directory information recorded on the information storage medium 100 and the directory information recorded in the local storage are first read. There are three possible cases that may be discovered at this point: a first case where files with an identical name exist only in the information storage medium 100 or the local storage, a second case where files with an identical name exist in both of the information storage medium 100 and the local storage, and a third case where a file in the information storage medium 100 is combined with a file in the local storage to create a new file.

In the first case, data is created in the virtual file system with reference to data in the information storage medium 100 or the local storage. As illustrated in FIG. 5, an AV stream 01000.m2ts 512 and application data aa.jar 514 exist only in the information storage medium 100, and a play list 00001.mpls 522, an AV stream 02000.m2ts 524, and application data bb.jar 526 exist only in the local storage. Accordingly, in the virtual file system, the AV stream 01000.m2ts 512 and the AV stream 02000.m2ts 524 are stored in a STREAM directory, the play list 00001.mpls 522 is stored in a PLAYLIST directory, and the application data aa.jar 514 and the application data bb.jar 526 are stored in a BD-J directory, as the file names are all different.

When a reproduction engine to reproduce HDMV titles or a Java application requests data from the virtual file system, the reproducing apparatus identifies the location of real data on the information storage medium 100 or the local storage corresponding to the data in the virtual file system with reference to directory information of the virtual file system and reads the real data from the information storage medium 100 or the local storage.

In the second case, files with an identical name exist in the information storage medium 100 and the local storage. In this case, the virtual file system reads data from the information storage medium 100 or the local storage according to predetermined conditions and provides the data to an application or a navigation engine. In other words, the virtual file system may be created using a newest version of a file or a new file based on a file version or a file creation date.

In the third case, data in the information storage medium 100 and data in the local storage are all referred to. In FIG. 5, a play list 00000.mpls 510 in the information storage medium 100 and a play list 00000_{—}1.mpls 520 in the local storage are combined into a single play list, and the virtual file system is created using the combined play list. For example, when a contents producer desires to provide additional data in addition to data already in the information storage medium 100, the contents producer may have the opportunity to download only the additional data, combine the downloaded data with the data in the information storage medium 100, and reproduce the combined data, instead of downloading new data, which is a combination of the data already in the information storage medium 100 and the additional data, from a server.

The virtual file system described above may be used to achieve various results. For example, when the moving picture in the information storage medium 100 includes navigation data comprising an English caption and audio data, a contents producer may additionally produce a Korean caption and audio data and provide the Korean caption, the audio data, and relevant navigation data through a server. Then, a user may download the Korean caption, the audio data, and the relevant navigation data through a network and stores the Korean caption, the audio data, and the relevant navigation data in the local storage.

With reference to the virtual file system, the reproducing apparatus combines the navigation data in the information storage medium 100 with the downloaded navigation data and uses the combined navigation data as a single navigation file. Therefore, the Korean caption, the audio data, and the corresponding navigation data stored in the local storage may be reproduced together with the moving picture in the information storage medium 100. A presentation engine of the reproducing apparatus, which executes the navigation file or a Java application which uses the navigation file, reproduces the moving picture as if contents stored in two locations from one file using the virtual file system.

Once the virtual file system is created, the reproducing apparatus reproduces an AV stream stored in the information storage medium 100 or the local storage with reference to the virtual file system. As is illustrated in FIG. 5, the directory structure of the virtual file system is identical to that of the information storage medium. Since the information storage medium 100 is read-only, data generated when an application is executed (i.e., when a Java application is executed) cannot be recorded on the information storage medium 100. However, the virtual file system includes a region in which data generated by an application may be recorded.

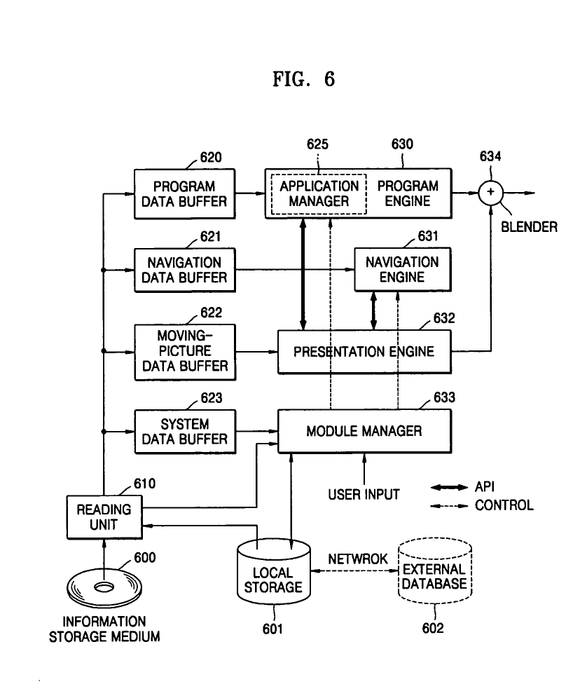

A reproducing apparatus which reproduces a moving picture using a virtual file system created as described above will now be described in detail. FIG. 6 is a block diagram of a reproducing apparatus according to an embodiment of the present invention.

Referring to FIG. 6, the reproducing apparatus includes a reading unit 610 that reads data from an information storage medium 600, a program data buffer 620, a navigation data buffer 621, a moving-picture data buffer 622 and a system data buffer 623, all of which temporarily store the read data, and a reproducing unit that acts as a reproduction engine to reproduce the buffered data. The reproducing unit includes a module manager 633, a navigation engine 631, a presentation engine 632, and a program engine 630. The module manager 633 reads system data and controls the navigation engine 631 to process a title change due to initialization and a user's choice or a navigation change. The navigation engine 631 controls the reproduction of a moving picture based on navigation data. The presentation engine 632 decodes moving-picture data and displays the decoded moving-picture data on a screen. The program engine 630 executes an application program. A plurality of program engines may be used depending on the type of application. For example, to subsequently reproduce a Java application and an HTML application, a Java virtual machine that executes the Java application and a browser engine that executes the HTML application are required.

The reproducing apparatus further includes a blender 634 which blends an output of the program engine 630 with an output of the presentation engine 632 such that the two outputs are overlaid on the screen. The program engine 630 may further include an application manager 625 that controls the execution of an application program using an application object to provide a program operation.

The reproducing apparatus also includes a local storage 601 which stores program applications downloaded from the information storage medium 600 or an external database 602. The module manager 633 creates a virtual file system using data read from the information storage medium 600 and data read from the local storage 601, and transmits reproduction control information to the program engine 630 and the navigation engine 631.

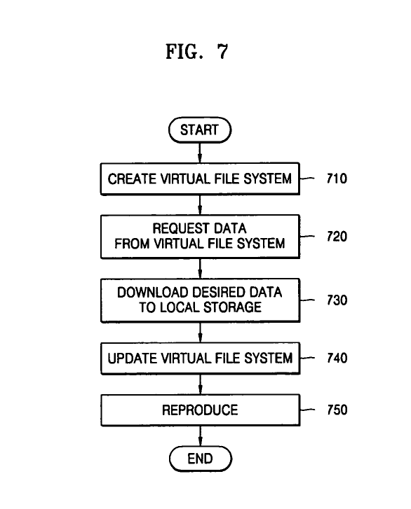

FIG. 7 is a flowchart illustrating a reproduction method using a virtual file system according to an embodiment of the present invention. Referring to FIG. 7, when the information storage medium 100 or 600 is inserted into the reproducing apparatus, a virtual file system is created (710). However, when none of the data in the local storage 601 is related to the information storage medium 100 or 600, the virtual file system is not created. Instead, a directory structure of the information storage medium 100 or 600 is used. Next, a reproduction engine for reproducing HDMV titles or a Java application requests data from the virtual file system (720).

The Java application recorded on the information storage medium 100 or 600 downloads data from a server to the local storage 601 through a network (730). The Java application or an application provided by the reproducing apparatus stores the downloaded data in a directory within the local storage 601. Then, the application that downloaded the data requests an update of the virtual file system. In response to the update request, the reproducing apparatus updates the virtual file system at a predetermined time, for example, when a title is changed or the reproduction of a moving picture is stopped (740). The application or the reproduction engine reads data from the information storage medium 100 or 600 or reads the downloaded data with reference to the updated virtual file system and reproduces the read data (750).

Two entities access data using the virtual file system: the navigation engine 631 to reproduce HDMV titles, and the Java application. When navigation data is selected by, for example, a user, the navigation engine 631 reads data corresponding to the selected navigation data while referring to the virtual file system and reproduces the read data. The navigation engine 631 perceives and accesses the virtual file system in the same manner as the navigation engine 631 perceives and accesses the information storage medium 100 or 600.

The Java application executes another application using the virtual file system or reads data such as HDMV navigation data or image data using the API. In addition, an application may store self-created data that is created during execution using a Java 10 and the virtual file system, and may read the stored data. The virtual file system stores data created by an application in a predetermined region (which can be distinguished by an application ID) of the local storage 601 and reads or removes the data at the request of the application.

The application perceives the predetermined region distinguished by the application ID as a basic directory thereof and accesses the predetermined region using the Java 10. In other words, when the application provides a command to access a file using the Java 10, the reproducing apparatus searches the predetermined region for the file, and transmits the search result to the application. Since different applications have different regions as their basic directories, data stored in the regions may be distinguished.

As is described above, according to an aspect of the present invention, a contents producer may create an application which accesses data stored in a local storage or an information storage medium and, thus, add new contents.

The present invention may also be implemented as computer-readable code on a computer-readable recording medium. The computer-readable recording medium is any data storage device that stores data that is thereafter read by a computer system. Examples of the computer-readable recording medium include read-only memory (ROM), random-access memory (RAM), CD-ROMs, magnetic tapes, floppy disks, optical data storage devices, and carrier waves (such as data transmission through the Internet).

The computer-readable recording medium may also be distributed over network-coupled computer systems so that the computer-readable code is stored and executed in a distributed fashion. Also, operational programs, code, and code segments to accomplish the present invention may be construed by programmers skilled in the art to which the present invention pertains.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A reproducing apparatus comprising:
a local storage to store data downloaded from a network;
a reading unit to read data stored in an information storage medium and to read the data stored in the local storage; and
a reproducing unit to create a virtual file system and to reproduce the data stored in the information storage medium in connection with the data stored in the local storage with reference to the virtual file system.

2. The apparatus of claim 1, wherein directory information of the virtual file system has a same format as directory information of the data stored in the information storage medium.

3. The apparatus of claim 1, wherein the reproducing unit comprises a module manager to create the virtual file system by combining directory information of the data stored in the local storage and directory information of the data stored in the information storage medium.

4. The apparatus of claim 3, wherein, when a file in a directory of the data stored in the local storage and a file in a directory of the data stored in the information storage medium have identical file names, the module manager selects one of the files with the identical file names based on a predetermined standard.

5. The apparatus of claim 3, wherein, when creating the virtual file system, the module manager combines a file in the directory of the data stored in the local storage and a file in the directory of the data stored in the information storage medium into one file when the two files are related.

6. The apparatus of claim 1, wherein the virtual file system comprises an application directory that relates to data created when an application, which is stored in the information storage medium or the local storage and which is executed, is stored.

7. The apparatus of claim 6, wherein the application directory comprises an identification (ID) to distinguish the application.

8. The apparatus of claim 6, wherein the application comprises an application program interface (API) operation and regards the application directory as a basic directory and reads or writes a file using the API operation based on the basic directory.

9. A method of reproducing multimedia data using a virtual file system, the method comprising:
storing data downloaded from a network in a local storage;
reading data stored in an information storage medium and the data stored in the local storage; and
creating the virtual file system and reproducing the data stored in the information storage medium in connection with the data stored in the local storage with reference to the virtual file system.

10. The method of claim 9, wherein the virtual file system has a format that is similar to a format of directory information stored in the information storage medium.

11. The method of claim 9, wherein the virtual file system is created by combining directory information of the data stored in the local storage and directory information of the data stored in the information storage medium.

12. A method of reproducing multimedia data using a virtual file system, the method comprising:
creating a virtual file system;
requesting data from the virtual file system using a reproduction unit or an application which reproduces audio-visual data;
reading data from an information storage medium or downloading data from a server through a network with reference to the virtual file system;
updating the virtual file system; and
reproducing the data read from the information storage medium in connection with the downloaded data with reference to the updated virtual file system.

13. The method of claim 12, wherein the virtual file system has a format that is similar to a format of directory information stored in the information storage medium.

14. The method of claim 12, wherein the updating of the virtual file system comprises combining directory information of the downloaded data and directory information of the data stored in the information storage medium.

15. The method of claim 14, wherein, when a file in a directory of the downloaded data and a file in a directory of the data stored in the information storage medium have identical file names, the updating of the virtual file system further comprises updating the virtual file system by selecting one of the files with the identical file names based on a predetermined standard.

16. The method of claim 14, wherein the updating of the virtual file system further comprises updating the virtual file system by combining a file in the directory of the downloaded data and a file in the directory of the data stored in the information storage medium into one file when the two files are related.

17. The method of claim 12, wherein the virtual file system comprises an application directory in relation with a space in which data created when an application stored in the information storage medium or a local storage is executed is stored.

18. The method of claim 17, wherein the directory of the application directory comprises an identification (ID) to distinguish the application.

19. A computer-readable recording medium storing a program to execute the method of claim 9.

20. A method of reproducing data by creating a virtual file system with directory information using directory information of an information storage medium and directory information of a local storage, comprising:
reading the directory information recorded on the information storage medium and the directory information recorded in the local storage; and
if files, including first data, exist in the information storage medium or the local storage, creating secondary data in the virtual file system that refers to the existing files as existing in the information storage medium or the local storage, identifying a location of the first data corresponding to the data in the virtual file system with reference to the directory information of the virtual file system, and reading the first data from the information storage medium or the local storage, or
if files, including third data, with an identical name exist in both of the information storage medium and the local storage, reading the third data from the information storage medium or the local storage according to predetermined conditions, and providing the read third data to an application or a navigation engine, or
if a file, including fourth data, in the information storage medium is to be combined with a file, including fifth data, in the local storage to create a new file, creating sixth data referring to the fourth data in the information storage medium and the fifth data in the local storage in the virtual file system.

21. The method according to claim 20, wherein the reading and the providing of the third data each comprises using a newer version of the files with the identical name.

22. A computer-readable recording medium storing a program to execute the method of claim 20.

23. A method of reproducing multimedia data using a virtual file system, the method comprising:
creating a virtual file system using directory information of an information storage medium and directory information of a local storage;
requesting data from the virtual file system;
reading data from the information storage medium or downloading data from a server to the local storage with reference to the virtual file system;
combining directory information of the downloaded data and directory information of the data stored in the information storage medium; and
reproducing the data read from the information storage medium in connection with the downloaded data with reference to the updated virtual file system.

24. A reproducing unit of an apparatus, having a local storage, to record/reproduce data read from the local storage and/or a medium inserted therein, the reproducing unit comprising:
a navigation engine to control the reproduction of a moving picture based on navigation data read from the medium;
a program engine to execute an application program related to the navigation data and/or the data from the medium to be reproduced and/or to execute the application program to download external data to the local storage; and
a module manager to create a virtual file system using data read from the information storage medium and/or data read from the local storage, and to transmit reproduction control information to the program engine and the navigation engine based on data stored in the virtual file system.

25. The reproducing unit according to claim 24, wherein the module manager reads system data and controls the navigation and program engines to process a title change due to initialization, a user choice, and/or a navigation change.

26. The reproducing unit according to claim 24, wherein the program engine may be plural in number, such that, when subsequently reproducing a Java application and an HTML application, the reproducing unit comprises:
a program engine to execute the Java application; and
a program engine to execute the HTML application.

27. The reproducing unit according to claim 24, further comprising a presentation engine to decode data of the moving-picture and to display the decoded moving-picture data.

28. The reproducing unit according to claim 27, further comprising:
a screen on which the data from the medium may be reproduced;
a blender to blend an output of the program engine with an output of the presentation engine such that the two outputs are overlaid on the screen, wherein the program engine comprises an application manager to control the execution of an application program using an application object to provide a program operation.

29. A reproduction method using a virtual file system for use with a recording/reproducing apparatus, having a local storage, into which a medium may be inserted, comprising:
creating a virtual file system when the information storage medium is inserted into the reproducing apparatus;
requesting data from the virtual file system to allow for an execution of a Java application;
downloading and storing data from a server to the local storage, upon the execution of the Java application;
requesting an update of the virtual file system and responsively updating the virtual file system at a predetermined time; and
reading data from the medium or reading the downloaded data with reference to the updated virtual file system and reproducing the read data.

30. The method according to claim 29, wherein the requesting further comprises requesting data from the virtual file system to allow for a reproduction of HDMV titles.

31. The method according to claim 29, wherein the predetermined time to update the virtual file system occurs when a title is changed or a reproduction of a moving picture is stopped.

32. A computer-readable recording medium storing a program to execute the method of claim 29.
